(19) United States
(12) Patent Application Publication
(10) Pub. No.: US 2020/0129273 A1
(43) Pub. Date: Apr. 30, 2020

(54) FASTENING DEVICE FOR A DENTAL PROSTHESIS

(71) Applicant: bredent GmbH & Co. KG, Senden (DE)

(72) Inventor: Peter BREHM, Senden (DE)

(73) Assignee: bredent GmbH & Co. KG, Senden (DE)

(21) Appl. No.: 16/606,867

(22) PCT Filed: May 28, 2018
(86) PCT No.: PCT/EP2018/063951

§ 371 Date: Oct. 21, 2019

(30) Foreign Application Priority Data
Jun. 14, 2017 (DE) 10 2017 113 148.5

(51) Int. Cl. A61C 8/00

(52) U.S. Cl. CPC A61C 8/0062; A61C 8/0068

(57) ABSTRACT

A fastening device for a dental prosthesis, in particular for use with a plurality of implants in the mouth of a patient, has a lower part, which is connectable to an implant along a first axis and has a holding element which is arranged along a second axis and is enclosed by an upper part, wherein the upper part is suitable for connection to a dental prosthesis, wherein an adhesion gap is formed between upper part and lower part and, after introduction of an adhesive material, permits a compensation between upper part and lower part.

The invention relates to a fastening device for a dental prosthesis, in particular for use with multiple implants in the mouth of a patient.

From the general state of the art, it is known that dental bridges can be used for the production of partial prostheses or full prostheses, in that these are set onto implants anchored in the jaw. For this purpose, the actual position of the implants is usually transferred by means of molding, after implantation, for adaptation of the dental bridge, so that the bridge can be produced with a precise fit. Setting of the implants at the intended positions takes place by means of guided implantation, for example, by means of a suitable template or, alternatively, by means of free-hand work by the surgeon. In this regard, it is not easily possible to put immediate stress on the set implants by putting the prosthesis, which was produced before the operation, in place.

Frequently, however, it is observed that the implants do not precisely correspond to the state originally planned with regard to their position immediately after the implants are set into the jaw, so that position imprecisions occur between the implants and the dental bridge.

Different arrangements are known as connection elements between dental prosthesis and implant.

For example, a double crown, in particular in the form of a telescoping crown is known from DE 10 2008 064 273 A1, which crown is intended for the production of tooth replacements in the form of bridges, supraconstructions and the like. It consists of a primary crown that can be fastened onto a tooth stump or an abutment of an implant, and furthermore of a secondary crown provided in the tooth replacement, which can be set onto the primary crown. A spacer crown is provided between the primary crown and the secondary crown, which spacer crown is either firmly connected with the primary and secondary crown or stands in connection with at least one of these crowns, with friction fit.

A connection device for fastening a dental prosthesis onto a jaw bone, having at least two connection elements, is known from DE 10 2008 058 305 A1, which elements each have an implant to be inserted into a jaw bone and a patrix that extends along a patrix axis of the implant, for connection with a dental prosthesis. In this regard, it is provided that the patrix axes along which the patrices of at least two connection elements extend in the case of connection elements disposed in a jaw bone run essentially parallel to one another. Furthermore, this document describes a further connection device and a method for the production of a connection device for fastening a dental prosthesis to a jaw bone. In this way, a connection device for fastening a dental prosthesis to a jaw bone as well as a method for the production of a connection device are created, which allow easy placement of a prosthesis on a jaw bone. For the production of the patrices described in this document, it is also possible to use a CAD/CAM method (CAD/CAM: Computer Aided Design/Computer Aided Manufacturing).

Although it is true that immediately after setting, a change in position of the implant is still possible by means of pressure on the cortical layer immediately adjacent to the implant, radial pressure stress would hinder osseointegration of the implant later. Accordingly, both setting of the implant and individual production of the connection elements provided for fastening of the dental prosthesis, carried out by means of a CAD/CAM method, for example, require great precision, which cannot always be guaranteed.

It is therefore a task of the invention to create a fastening device for a dental prosthesis, in particular for use with a plurality of newly set implants in the mouth of a patient, which method overcomes the disadvantages mentioned above and allows a certain robustness to tolerances.

This task is accomplished by means of the independent claim 1. Further advantageous embodiments of the invention are the object of the dependent claims, in each instance. These can be combined with one another in technologically practical manner. The description, in particular in connection with the drawing, additionally characterizes and specifies the invention.

According to the invention, a fastening device for a dental prosthesis, in particular for use with multiple implants in the mouth of a patient, is indicated, which device has a lower part that can be connected with an implant along a first axis and has a holding element disposed along a second axis, which element is enclosed by an upper part, wherein the upper part is suitable for connection with a dental prosthesis, wherein an adhesion gap is formed between upper part and lower part, which gap allows compensation between upper part and lower part after introduction of an adhesive material.

The fastening device according to the invention thereby makes available a possibility for creating position equalization between a dental prosthesis assigned to the upper part and an implant or multiple implants assigned to the lower part. The adhesion gap thereby serves for correction of position imprecisions during setting the implant or implants, or of production tolerances during production of the required parts. Accordingly, the lower part, in particular, can be pre-produced with regard to the geometrical configuration such as angulation or shaping in the region of the gingiva, and can be individually produced, in patient-specific manner, for example by means of a CAD/CAM method. Possible deviations can be compensated by way of the adhesion gap, so that the dental prosthesis can be set onto the implants by means of the fastening device according to the invention, without exerting mechanical forces in this regard, in particular forces that act in the radial direction, which forces could hinder osseointegration of the implants. To form an adhesion gap, the upper part can enclose the lower part completely or also only in certain sections.

According to an embodiment of the invention, the adhesion gap between upper part and lower part has a drain channel.

The drain channel can therefore be used to discharge excess adhesive material, and this facilitates the use of the fastening device according to the invention, in particular, since precise application of the adhesive material, with a predetermined volume, is not necessary.

According to a further embodiment of the invention, the adhesion gap covers the holding element completely or completely at least in certain sections.

Accordingly, in the case of the fastening device according to the invention, it is possible to achieve both stable fastening of the dental prosthesis on the implant or implants, and sealing of the upper part relative to the lower part, to prevent deposits.

According to a further embodiment of the invention, the first axis and the second axis have an angle relative to one another.

In particular in the case of production by means of CAD/CAM methods, the angulation of the fastening device can be selected individually, so that an orientation of the first axis relative to the second axis that is adapted to the mouth situation can be selected.

According to a further embodiment of the invention, the first axis and the second axis have the same orientation.

The fastening device according to the invention can be used even in the case of lower parts having a straight shape, in which holding element and implant are oriented in the same direction. Angulated and non-angulated embodiments can, of course, also be selected differently for different implant positions.

According to a further embodiment of the invention, the upper part has an opening disposed on the top side, which opening is provided with an inside thread, into which a removal screw can be introduced along the second axis.

Within the scope of treatment of a patient, it is often unavoidable to remove the upper part so as to obtain access to the lower part with the implant that lies underneath; according to the invention, this can be done in simple manner using the removal screw, without having to exert excessive forces on the implants during this process.

According to a further embodiment of the invention, the lower part is structured as an abutment.

In this regard, the lower part can be adapted to different implants, depending on its use, so as to create compatibility with different implant embodiments.

According to a further embodiment of the invention, the lower part is pre-produced in patient-specific manner.

The lower part can be pre-produced, in particular, with regard to the angulation, i.e. the angle between the first and the second axis, and/or in the region of the gingiva transition, for gingiva formation for the respective mouth situation at the planned implant position, so that the best possible patient-specific use becomes possible.

According to a further embodiment of the invention, the upper part can be connected with a cap, which is suitable for accommodating a dental prosthesis.

In this regard, the cap can be releasably fastened onto the upper part with any desired connection types known from the state of the art. Aside from fastening with holding rings or spring washers, splinting or screw connections are also possible.

According to a further embodiment of the invention, a further adhesion gap is formed between the cap and the dental prosthesis.

Possible deviations can be compensated by way of the adhesion gap along or in combination with the further adhesion gap or also solely by means of the further adhesion gap, so that the dental prosthesis can be placed onto the implants without exerting mechanical forces, by means of the fastening device according to the invention.

In the following, some exemplary embodiments will be explained in greater detail using the drawing. The figures show:

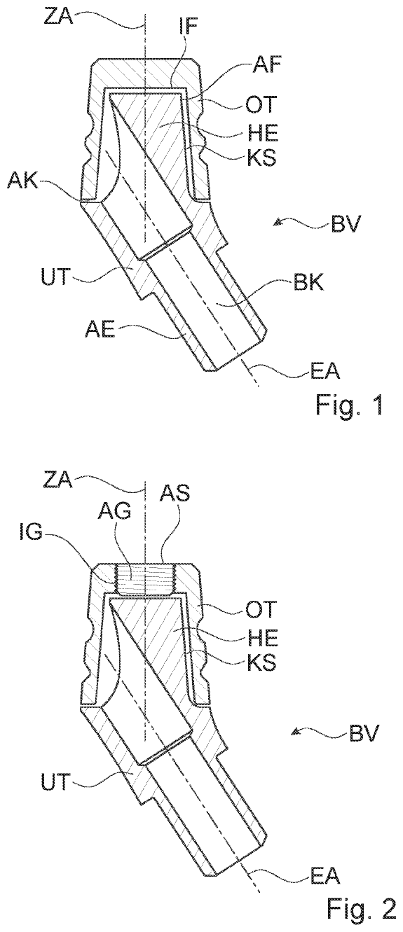

FIG. 1 a fastening device according to the invention in a sectional view,

FIG. 2 a further fastening device according to the invention in a sectional view,

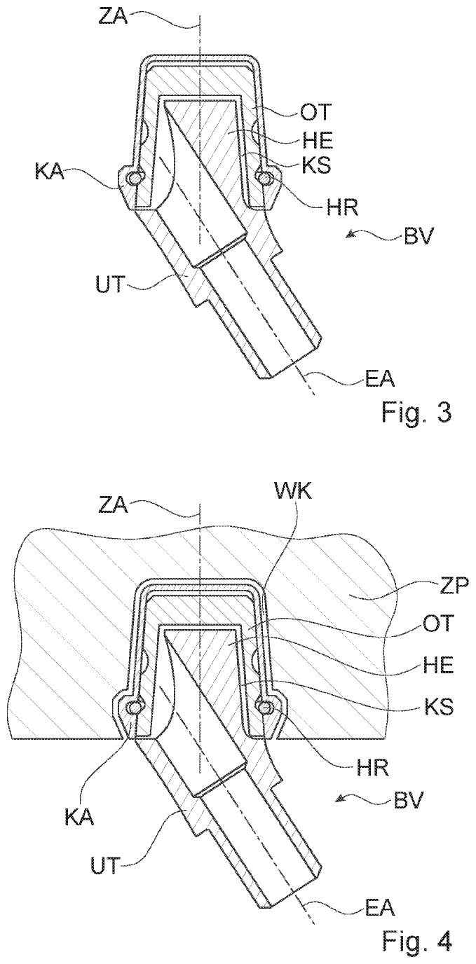

FIG. 3 a further fastening device according to the invention in a sectional view,

FIG. 4 a further fastening device according to the invention in a sectional view.

In the figures, the same or functionally equivalent components are provided with the same reference symbols.

In FIG. 1, a first embodiment of a fastening device BV according to the invention is shown in a sectional view. The fastening device BV has a lower part UT, which has an accommodation element AE at its lower end, which element is configured to have rotation symmetry about a first axis EA; the element is penetrated by a fastening channel for holding a fastening screw. The accommodation element can be introduced into an implant (not shown in FIG. 1), for example, and can be secured in the fastening channel BK by means of a screw, not shown.

Essentially with rotation symmetry about a second axis ZA, which has an individually adapted angle relative to the first axis EA, a holding element HE is configured, which element has the structure of a truncated cone except for the region that is penetrated by the fastening channel BK. The lower part UT thereby represents an individually adapted abutment, which can be introduced into an implant.

An upper part OT, which encloses the holding element HE, can be placed onto the holding element HE. For this purpose, the upper part has inner surfaces IF, which correspond with corresponding outer surfaces AF of the lower part UT, wherein once again, the region of the fastening channel BK is excepted. Therefore an adhesion gap KS is formed between the inner surface IF and the outer surface AF, which gap can be filled with an adhesive material, so that the upper part OT is fixed in place on the lower part UT. Typically, the upper part OT is brought into connection with a dental prosthesis, so that the dental prosthesis can be fastened to the implant by way of the upper part OT and the lower part UT. Aside from the structure as a truncated cone, as shown, in the region of the adhesion gap KS, other embodiments, for example with straight side surfaces, are also possible.

In this regard, the adhesion gap KS is configured also in the region below the lower end of the upper part OT, so that excess adhesive in the adhesion gap KS can be discharged to the outside. In yet other embodiments, however, it is also possible to provide a special drain channel AK, as indicated in FIG. 1.

In FIG. 2, a second embodiment of the fastening device BV according to the invention is shown. In contrast to the embodiment according to FIG. 1, here the upper part OT has an opening, delimited by the inside thread IG, through which a removal screw AS, structured as a headless screw, is passed. In this regard, to separate the upper part OT from the lower part UT, the removal screw AS is introduced, with its outside thread AG, further into the inside thread IG along the second axis ZA, so that the screw, as soon as it enters into a connection with the holding element HE, brings about a removal force, so that the upper part OT can be released from the lower part UT. The removal screw AS can support itself on the top side of the holding element HE. The top side of the upper part OT can form a planar surface with the top side of the removal screw AS, until the removal function is used.

After the upper part OT has been released from the lower part UT, the lower part UT can be removed from the implant by loosening a screw in the fastening channel BK, so that this screw is now accessible. It is possible to overcome the holding force of the adhesive material in the adhesion gap KS by means of a removal screw AS, without applying forces, in this regard, that would act on the implant predominantly in the radial direction, so that it would be made more difficult for the implants to become integrated into the jaw bone.

In FIG. 3, a third embodiment of the fastening device BV according to the invention is shown. In addition to the embodiment according to FIG. 1, here a cap KA and a holding ring HR are provided, which ring engages into corresponding annular grooves between cap KA and upper part OT. In this way, it is possible to remove a dental prosthesis that can be brought into connection with the upper part OT by way of the cap KA shown in FIG. 3, so that adjustments, replacements or cleanings, for example, can be undertaken.

Aside from fastening using the holding ring HR, cap KA and upper part OT can be releasably connected in diverse other ways. For example, possibilities would also be splinting, screw connection or placement of a spring washer or other retentive elements.

Connection of a dental prosthesis ZP with the cap is shown in FIG. 4 as a fourth embodiment, together with the fastening device BV according to the invention is shown. In addition to the embodiment according to FIG. 3, a further adhesion gap WK is provided between cap KA and upper part OT. Thereby it is possible for deviations that might occur to be compensated by way of the further adhesion gap WK, so that the dental prosthesis can be placed onto the implants without exerting mechanical forces by means of the fastening device BV according to the invention. Here, the adhesion gap KS between upper part OT and lower part UT can optionally also be selected with a lesser distance, since now the further adhesion gap WK is now also available for compensation.

The fastening device BV according to the invention is suitable, in particular, for use of freshly set implants, since adaptation to the individual situation of a patient is possible by means of the adhesion gap KS and/or the further adhesion gap WK.

Accordingly, lower parts can be individually produced as abutments at the respective implant positions, in patient-specific manner, for example by means of a CAD/CAM method. Possible deviations can be compensated by way of the adhesion gap KS alone or in combination with the further adhesion gap WK or even solely by means of the further adhesion gap WK, so that the dental prosthesis can be placed on the implants by means of the fastening device BV according to the invention, without exerting mechanical forces. In this regard, the dimensioning of the adhesion gap KS can be undertaken in such a manner that deviations of a few degrees (for example 3°) can be compensated. Greater compensation is possible with regard to the dimensioning of the further adhesion gap WK.

The characteristics indicated above and in the claims, as well as those that can be derived from the figures, can be advantageously implemented both individually and in various combinations. The invention is not restricted to the exemplary embodiments that have been described, but rather can be modified in many different ways, within the scope of the ability of a person skilled in the art.

### LIST OF REFERENCE SYMBOLS

AE accommodation element
AF outer surface
AG outside thread
AK drain channel
AS removal screw
BK fastening channel
BV fastening device
EA first axis
HE holding element
HR holding ring
IF inner surface
IG inside thread
KA cap
KS adhesion gap
OT upper part
UT lower part
WK further adhesion gap
ZA second axis
ZP dental prosthesis

1: A fastening device for a dental prosthesis (ZP), in particular for use with multiple implants in the mouth of a patient, which has a lower part (UT) that can be connected with an implant along a first axis (EA) and has a holding element (HE) disposed along a second axis (ZA), which element is enclosed by an upper part (OT), wherein the upper part (OT) is suitable for connection with the dental prosthesis (ZP), wherein an adhesion gap (KS) is formed between upper part (OT) and lower part (UT), which gap allows compensation between upper part (OT) and lower part (UT) after introduction of an adhesive material.

2: The fastening device according to claim 1, in which the adhesion gap (KS) between upper part (OT) and lower part (UT) is provided with a drain channel (AK).

3: The fastening device according to claim 1, in which the adhesion gap (KS) completely covers the holding element (HE).

4: The fastening device according to claim 1, in which the first axis (EA) and the second axis (ZA) have an angle relative to one another.

5: The fastening device according to claim 1, in which the first axis (EA) and the second axis (ZA) have the same orientation.

6: The fastening device according to claim 1, in which the upper part (OT) has an opening disposed on the top side, which opening is provided with an inside thread (IG), into which a removal screw (AS) can be introduced along the second axis (ZA).

7: The fastening device according to claim 1, in which the lower part (UT) is structured as an abutment.

8: The fastening device according to claim 1, in which the lower part (UT) is pre-produced in patient-specific manner.

9: The fastening device according to claim 1, in which the upper part (OT) can be connected with a cap (KA), which is suitable for accommodating the dental prosthesis (ZP).

10: The fastening device according to claim 9, in which a further adhesion gap (WK) is formed between the cap (KA) and the dental prosthesis (ZP).
